(19) United States
(12) Patent Application Publication
(10) Pub. No.: US 2010/0302215 A1
(43) Pub. Date: Dec. 2, 2010

(54) LIQUID CRYSTAL DISPLAY DEVICE AND LIQUID CRYSTAL DISPLAY PANEL THEREOF

(76) Inventors: Tsung-Ting Tsai, Hsin-Chu (TW); Yung-Chih Chen, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/607,071

(22) Filed: Oct. 28, 2009

(30) Foreign Application Priority Data
May 27, 2009 (TW) 098117653

(51) Int. Cl. G09G 5/00; G09G 3/36

(52) U.S. Cl. 345/204; 345/98

(57) ABSTRACT

A pixel array of a liquid crystal display panel in a half source driver (HSD) model is provided. Each two pixels adjacent in the array location are connected to different data lines. Accordingly, the liquid crystal display panel adopting the driving manner of the column inversion can achieve the display effect of the dot inversion. Therefore, the present invention can substantially reduce the power consumption of the source driver and decrease the flicker effect.

### BACKGROUND OF THE INVENTION

1. Field of the Invention

The present invention relates to a display technique, especially a liquid crystal display and its liquid crystal display panel, with a half source driver (HSD) pixel array which substantially reduces the power consumption of source drivers.

2. Description of the Prior Art

The driving method of conventional liquid crystal display devices utilizes source drivers and gate drivers to drive pixels on display panels. Cost of the source driver is higher than that of the gate driver; in order to minimize the usage of the source drivers, a pixel structure with shared data lines has been developed using a HSD driving method. In other words, for the same amount of pixels, the HSD driving method has only half the amount of data lines of the source driver and doubled amount of gate lines of the gate driver, to reduce manufacturing cost.

In comparison to the conventional liquid crystal display device without dimidiating the data lines, the HSD driving method liquid crystal display device has fewer data lines thus the capacitance between pixel and data line (Cpd) is smaller. Therefore, a cross talk is unlikely to occur in the HSD driving method liquid crystal display device, which reduces the possibility of bright/dark lines on the display.

However, in order to maintain a same frame rate, frequency of gate driver signals is doubled which dimidiates the turn-on time of the gate driver signals. Therefore, under the circumstance of dimidiated turn-on time, it is more difficult to charge and deliver sufficient voltage level to the pixels to display correct images, causing insufficient charging.

### SUMMARY OF THE INVENTION

The present invention provides a liquid crystal display panel with the pixel array having the HSD driving method, and utilizes a column inversion driving manner to achieve the display effect of the dot inversion and to overcome problems of the prior art.

The present invention provides a liquid crystal display panel including a plurality of gate lines, a plurality of data lines, and a plurality of pixels arranged in a matrix form. A (4n+1)th gate line is coupled to a pixel of a (4m+1)th column of a (2n+1)th row and a pixel of a (4m+4)th column of a (2n+1)th row; a (4n+2)th gate line is coupled to a pixel of a (4m+2)th column of a (2n+1)th row and a pixel of a (4m+3)th column of a (2n+1)th row; a (4n+3)th gate line is coupled to a pixel of a (4m+2)th column of a (2n+2)th row and a pixel of a (4m+3)th column of a (2n+2)th row; a (4n+4)th gate line is coupled to a pixel of a (4m+1)th column of a (2n+2)th row and a pixel of a (4m+4)th column of a (2n+2)th row; a (2m+1)th data line is coupled to a pixel of a (4m+1)th column of a (2n+1)th row, and a pixel of a (4m+2)th column of a (2n+2)th row; a (2m+2)th data line is coupled to pixels of a (4m+2)th column and a (4m+4)th column of a (2n+1)th row, and pixels of a (4m+1)th column and a (4m+3)th column of a (2n+2)th row; a (2m+3)th data line is coupled to a pixel of a (4m+3)th column and a (2n+1)th row, and a pixel of a (4m+4)th column and a (2n+2)th row, wherein m and n are respectively an integer greater than or equal to 0.

The present invention further provides a liquid crystal display device which includes the above liquid crystal display panel, at least a driving control circuit to drive and control the liquid crystal display panel, and a backlight module to supply a light source for the liquid crystal display panel.

Therefore, the present invention of the liquid crystal display panel utilizes the column inversion driving manner, outputting the same and consistent polarized signals from every data line, to achieve the dot inversion polarity distribution on the display. Therefore, the present invention reduces the power consumption and loading of the source drivers as well as decreasing flicker effect on the display panel at the same time. To accomplish the objectives above and provide better understandings to the present invention, preferred embodiments of the present invention are illustrated in the accompanying drawings. However, the preferred embodiments and figures are for references only, and do not limit the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a first embodiment of the present invention liquid crystal display device.

FIG. 2 is an enlarged diagram illustrating the pixel P₁₁-Pᵢⱼ arrangements of the first embodiment.

FIG. 3 is a table demonstrating the pixel P₁₁-Pᵢⱼ connection rules of the first embodiment of the present invention.

FIG. 4 is a table illustrating the arrangement unit U₀₀ of the first embodiment.

FIG. 5 is a partial timing diagram illustrating the first embodiment of the present invention.

FIG. 6 is a schematic diagram of the liquid crystal display device.

FIG. 7 is a plan view diagram of a layout of a portion of pixels P₁₁-P₂₄ of the liquid crystal display device.

FIG. 8 is a block diagram of a liquid crystal display device 300 of a second embodiment.

### DETAILED DESCRIPTION

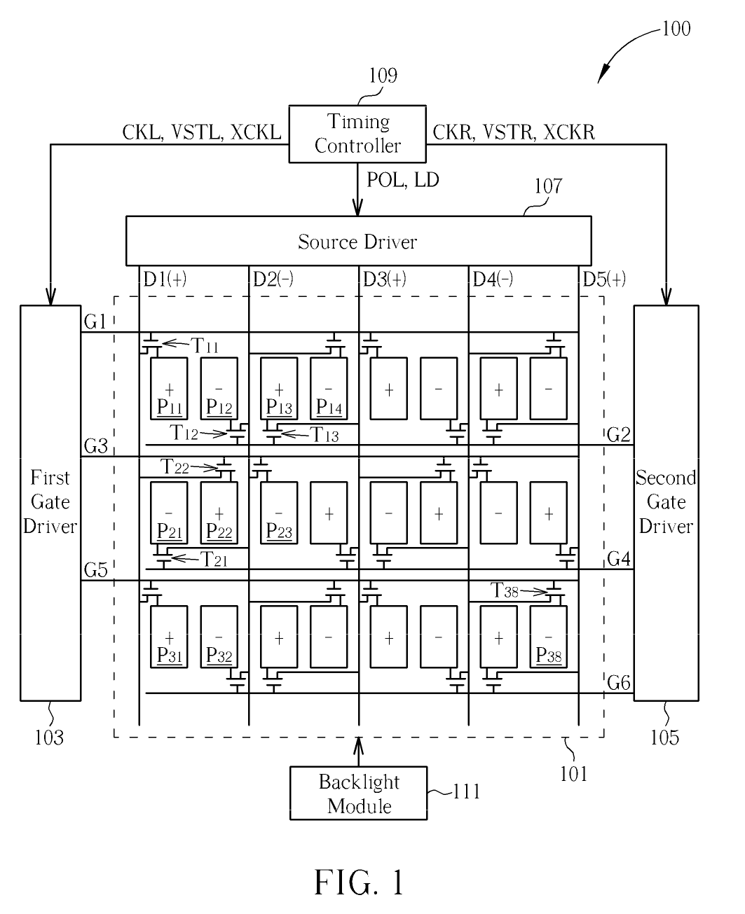

FIG. 1 is a block diagram of a first embodiment of the present invention liquid crystal display device 100. As illustrated in FIG. 1, the liquid crystal display device 100 includes a liquid crystal display panel 101, at least one driving control circuit for driving and controlling the liquid crystal display panel 101, and a backlight module 111 to supply the light source to the liquid crystal display panel 101. The at least one driving control circuit may include a first gate driver 103, a second gate driver 105, a source driver 107, and a timing controller 109. The liquid crystal display panel 101 includes a plurality of gate lines G₁-Gₓ, a plurality of data lines D₁-D_{y}, a plurality of pixels P₁₁-Pᵢⱼ arranged in a matrix form, and a plurality of thin film transistors T₁₁-Tᵢⱼ corresponding to pixels P₁₁-Pᵢⱼ, wherein x, y, i, and j are integers greater than or equal to 1. In order to demonstrate connections of the pixels clearly, FIG. 1 of the liquid crystal display panel 101 only illustrates, for example, 6 gate lines G₁-G₆, 5 data lines D₁-D₅, and 24 pixels P₁₁₋₃₈; the number of gate lines, data lines, and pixels in an actual liquid crystal display panel 101 is not limited.

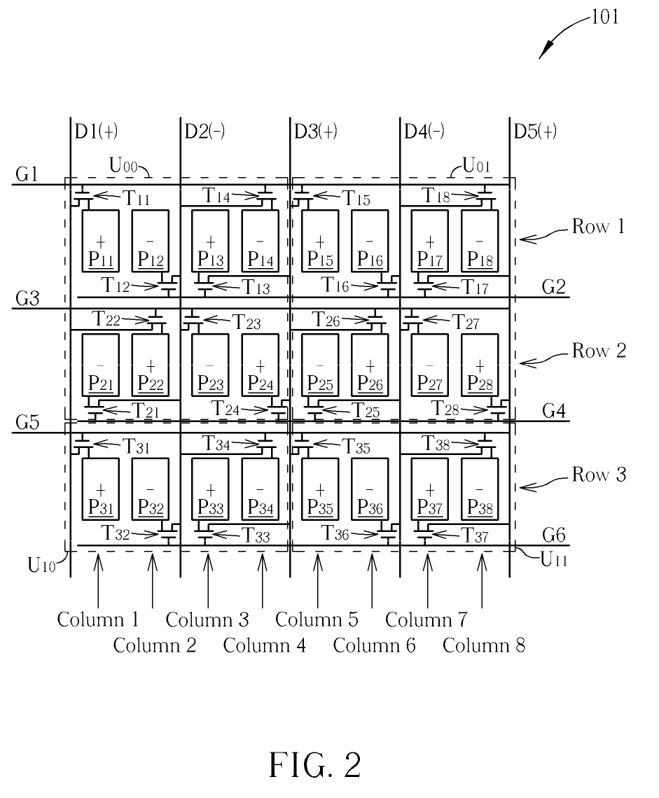

FIG. 2 is an enlarged diagram illustrating the pixel P₁₁-Pᵢⱼ arrangements of the first embodiment. As illustrated in FIG. 2, pixels within every 4 columns and 2 rows form an arrangement unit U, and the liquid crystal display panel 101 is composed of a plurality of arrangement units U₀₀-Uₙₘ arranged in a matrix form, wherein m and n are respectively an integer greater than or equal to 0. Units U₀₀-Uₙₘ could be complete arrangement units (such as a 4 columns by 2 rows), or combinations of complete arrangement units in a matrix form and partial arrangement units of surroundings (only include pixels of a 1 column by 2 rows, a 2 columns by 2 rows, a 3 columns by 2 rows, a 1 column by 1 row, a 2 columns by 1 row, a 3 columns by 1 row, or a 4 columns by 1 row). For instance, pixel P₁₁-Pᵢⱼ arrangements may also be combinations of complete arrangement units U₀₀-U₍ₙ₋₁₎₍ₘ₋₁₎, partial arrangement units Uₙ₀-Uₙₘ, and partial arrangement units U₀ₘ-U₍ₙ₋₁₎ₘ.

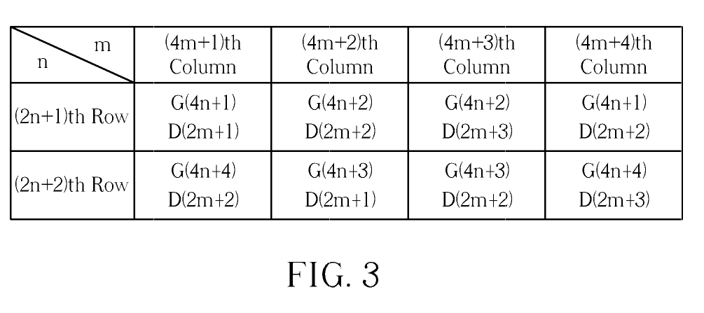

The pixel connections of Units Uₙₘ all follow the same rules. FIG. 3 is a table demonstrating the pixel P₁₁-Pᵢⱼ connection rules of the first embodiment of the present invention. As illustrated in FIG. 3, in every arrangement unit Uₙₘ, a (4n+1)th gate line G₍₄ₙ₊₁₎ is coupled to a pixel P₍₂ₙ₊₁₎₍₄ₘ₊₁₎ of a (4m+1)th column of a (2n+1)th row and a pixel P₍₂ₙ₊₁₎₍₄ₘ₊₄₎ of a (4m+4)th column of a (2n+1)th row; a (4n+2)th gate line G₍₄ₙ₊₂₎ is coupled to a pixel P₍₂ₙ₊₁₎₍₄ₘ₊₂₎ of a (4m+2)th column of a (2n+1)th row and a pixel P₍₂ₙ₊₁₎₍₄ₘ₊₃₎ of a (4m+3)th column of a (2n+1)th row; a (4n+3)th gate line G₍₄ₙ₊₃₎ is coupled to a pixel P₍₂ₙ₊₂₎₍₄ₘ₊₂₎ of a (4m+2)th column of a (2n+2)th row and a pixel P₍₂ₙ₊₂₎₍₄ₘ₊₃₎ of a (4m+3)th column of a (2n+2)th row; a (4n+4)th gate line G₍₄ₙ₊₄₎ is coupled to a pixel P₍₂ₙ₊₂₎₍₄ₘ₊₁₎ of a (4m+1)th column of a (2n+2)th row and a pixel P₍₂ₙ₊₂₎₍₄ₘ₊₄₎ of a (4m+4)th column of a (2n+2)th row; a (2m+1)th data line D₍₂ₘ₊₁₎ is coupled to a pixel P₍₂ₙ₊₁₎₍₄ₘ₊₁₎ of a (4m+1)th column of a (2n+1)th row, and a pixel P₍₂ₙ₊₂₎₍₄ₘ₊₂₎ of a (4m+2)th column of a (2n+2)th row; a (2m+2)th data line D₍₂ₘ₊₂₎ is coupled to pixels P₍₂ₙ₊₁₎₍₄ₘ₊₂₎ and P₍₂ₙ₊₁₎₍₄ₘ₊₄₎ of a (4m+2)th column and a (4m+4)th column of a (2n+1)th row, and pixels P₍₂ₙ₊₂₎₍₄ₘ₊₁₎ and P₍₂ₙ₊₂₎₍₄ₘ₊₃₎ of a (4m+1)th column and a (4m+3)th column of a (2n+2)th row; a (2m+3)th data line D₍₂ₘ₊₃₎ is coupled to a pixel P₍₂ₙ₊₁₎₍₄ₘ₊₃₎ of a (4m+3)th column and a (2n+1)th row, and a pixel P₍₂ₙ₊₂₎₍₄ₘ₊₄₎ of a (4m+4)th column and a (2n+2)th row.

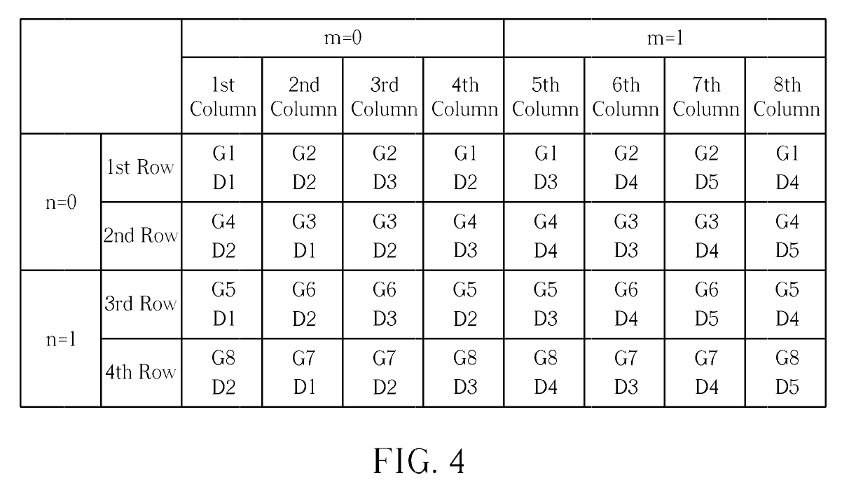

FIG. 4 is a table illustrating the arrangement unit U₀₀ of the first embodiment. As illustrated in FIG. 1 and FIG. 4, in an actual arrangement unit U₀₀, n equals to 0 and m equals to 0. For the time being, a gate line G₁ is coupled to pixels P₁₁ and P₁₄; a gate line G₂ is coupled to pixels P₁₂ and P₁₃; a gate line G₃ is coupled to pixels P₂₂ and P₂₃; a gate line G₄ is coupled to pixels P₂₁ and P₂₄; a data line D₁ is coupled to pixels P₁₁ and P₂₂; a data line D₂ is coupled to pixels P₁₂, P₁₄, P₂₁, and P₂₃; a data line D₃ is coupled to pixels P₁₃ and P₂₄.

Please again refer to FIG. 1, the timing controller 109 is coupled to the first gate driver 103, the second gate driver 105, and the source driver 107. The timing controller 109 receives external synchronize signals and time signals to generate gate electrode control signals for controlling the first and the second gate drivers 103 and 105, and to generate data control signals for controlling the source driver 107. In addition, the timing controller 109 rearranges external pixel data signals and delivers pixel data signals to the source driver 107, wherein pixel data signals include data signals of various color pixels.

In the present embodiment, the first gate driver 103 disposed at one side of the liquid crystal display panel 101 is coupled to a (4n+1)th gate line G₍₄ₙ₊₁₎ and a (4n+3)th gate line G₍₄ₙ₊₃₎ to provide first scan signals to all odd numbered gate lines in the liquid crystal display panel 101 in a serial way. Operation of the first gate driver 103 is controlled by the control signals CKL, VSTL, XCKL from the timing controller 109. The second gate driver 105 disposed on the other side of the liquid crystal display panel 101 is coupled to a (4n+2)th gate line G₍₄ₙ₊₂₎ and a (4n+4)th gate line G₍₄ₙ₊₄₎ to provide second scan signals to all even numbered gate lines in the liquid crystal display panel 101 in a serial way. Operation of the second gate driver 105 is controlled by the control signals CKR, VSTR, XCKR from the timing controller 109.

In other embodiments, two ends of each gate line G₁-Gₓ could also connect to a first gate driver 103 and a second gate driver 105 respectively. In other words, a single gate line may receive the first scan signals of the first gate driver 103 or the second scan signals of the second gate driver 105, under different scenarios such as selecting a closest gate driver for a shortest signal path.

The source driver 107 is coupled to all data lines D₁-D_{y} in the liquid crystal display 101 and is controlled by control signals LD and POL from the timing controller 109, to provide the data lines D₁-D_{y} with corresponding display data. Therefore, all pixels P₁₁-Pᵢⱼ receive corresponding display data from the corresponding data lines D₁-D_{y}. The source driver 107 converts the data signals received from the timing controller 109 to analog signals.

Therefore, the present invention of the liquid crystal display panel 101 utilizes the HSD driving method, and permits sharing of a common data line of pixels in different columns, dimidiating the number of data lines and reducing manufacturing cost of the source driver circuits as well as lowering the power consumption. As illustrated in FIG. 2, pixels P₁₃, P₂₄, P₁₅, and P₂₆ of columns 3 to 6 share a common data line D₃. Also, with the doubled number of gate lines, the number of gate lines G1-Gx will always be an even number. Therefore, the present embodiment may utilize disposing the first gate driver 103 and the second gate driver 105 from two sides to effectively reduce the manufacturing cost of the gate drivers.

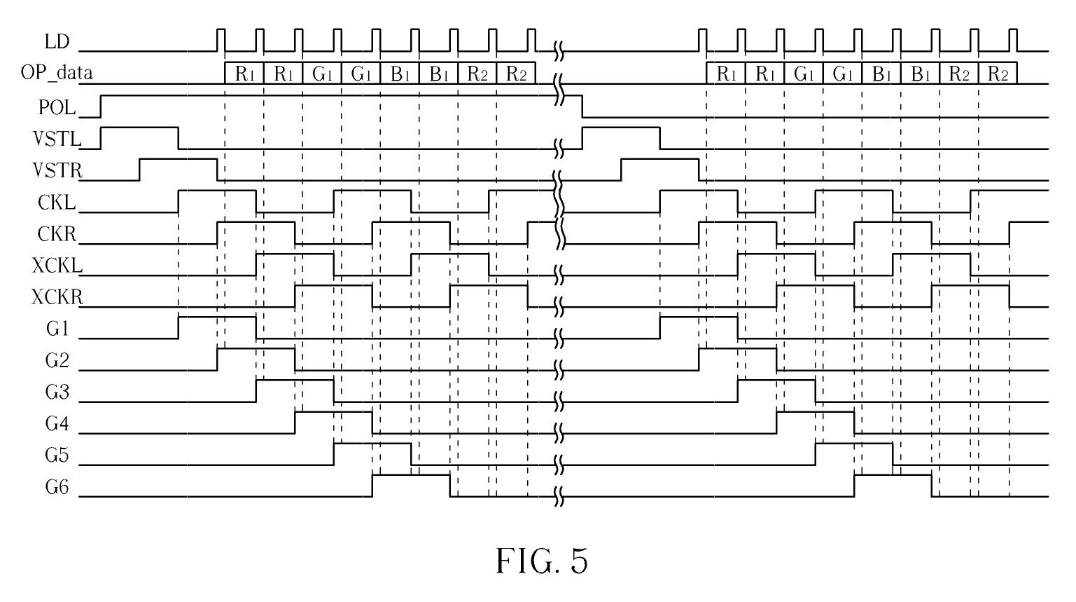

In order to better understand the liquid crystal display device 100, FIG. 5 is a partial timing diagram illustrating the first embodiment of the present invention. Please refer to FIG. 1 and FIG. 5 at the same time. According to the driving signal waveform diagram of FIG. 5, the first gate driver 103 and the second gate driver 105 are controlled by the control signals CKL, VSTL, XCKL, and CKR, VSTR, XCKR of the timing controller 109 respectively, which cross coordinate to provide scan signals to corresponding gate lines G₁-Gₓ of the liquid crystal display panel 101.

In addition, the source driver 107 is controlled by control signals LD and POL from the timing controller 109, to provide corresponding display data OP_data to each data line D₁-D_{y}. Therefore, every pixel P₁₁-Pᵢⱼ in the liquid crystal display panel 101 receives signals from the corresponding data lines D₁-D_{y} and writes the corresponding display data.

During one frame period of the liquid crystal display device 100 the first gate driver 103 and the second gate driver 105 drive the gate lines G₁-Gₓ of the liquid crystal display panel 101 in sequence in accordance to gate control signals from the timing controller 109. At a same time, the source driver 107 converts the pixel data signal received from the timing controller 109 to grey scale signals. Through switching on the coupled thin film transistors T₁₁-Tᵢⱼ, grey scale signals are delivered to corresponding red, green and blue pixels P₁₁-Pᵢⱼ.

As illustrated in FIG. 5, during a frame period of the liquid crystal display 100 for a data line (D₁, D₂, D₃ . . . or D_{y}), the delivered display data are of the same polarity, meaning the polarity determining control signal POL only requires a single conversion. For example, display data delivered by odd numbered data lines D₍₄ₘ₊₁₎ and D₍₄ₘ₊₃₎ are a first polarity; display data delivered by even numbered data lines D₍₄ₘ₊₂₎ and D₍₄ₘ₊₄₎ are a second polarity, wherein the first polarity is opposite to the second polarity. Therefore, the liquid crystal display panel 101 may utilize a column inversion driving manner. In the next frame, due to a polarity conversion by the control signal POL, the data line (D₁, D₂, D₃ . . . or D_{y}) delivers an opposite display data of the previous frame.

Due to each two pixels P₁₁-Pᵢⱼ that are adjacent in an array location being connected to a different data line D₁-D_{y}, during one frame period of the liquid crystal display device 100, the present invention of the liquid crystal display panel 101 utilizes the column inversion driving manner, outputting signals of a same polarity in every data line (D₁, D₂, D₃ . . . or D_{y}), to achieve the dot inversion polarity distribution for a better display effect. Therefore, the present invention not only greatly reduces the power consumption and loading of the source driver 107, but also decreases flicker effect of the liquid crystal display panel 101.

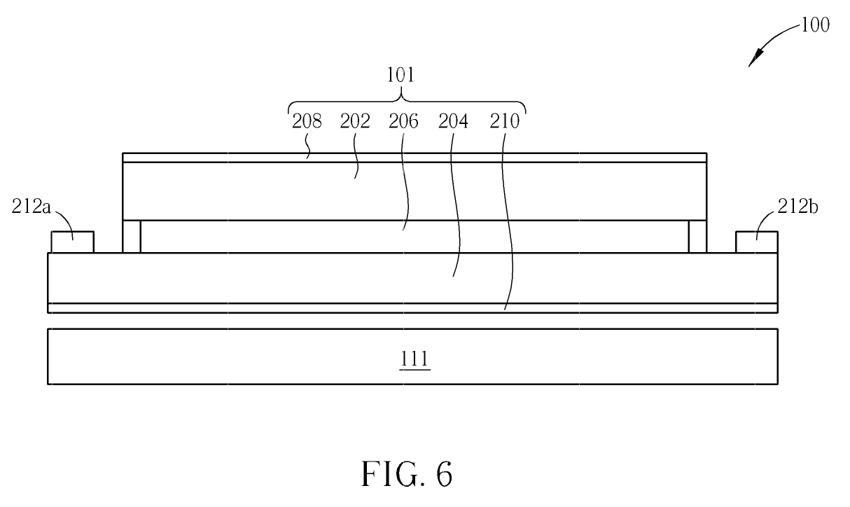

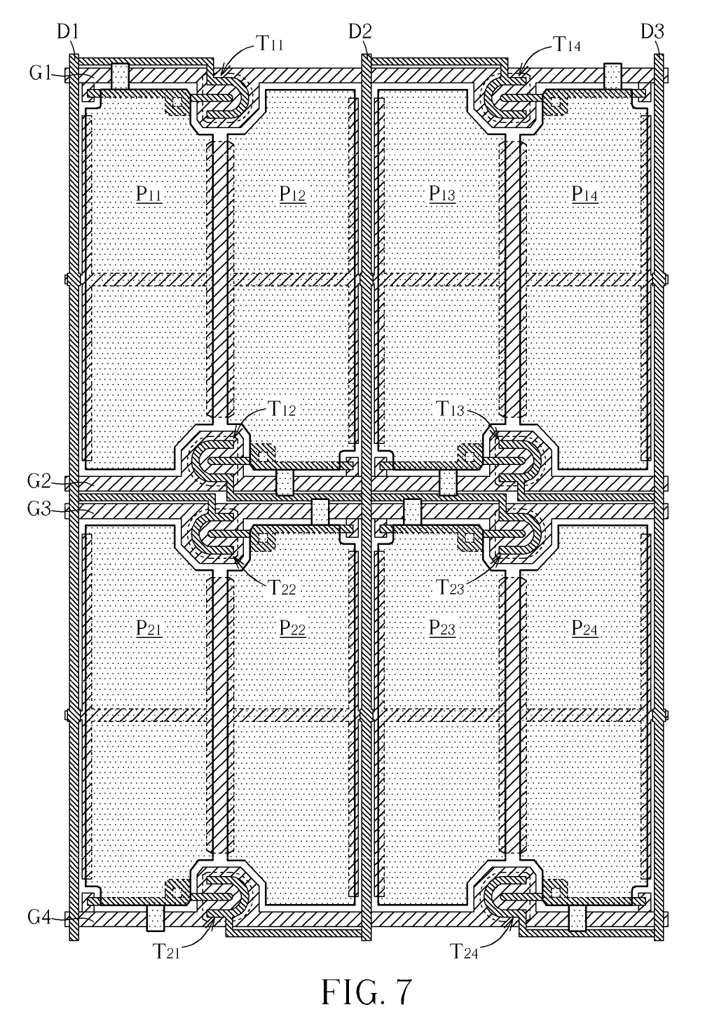

In order to better illustrate the structure of the liquid crystal display device 100 please refer to FIG. 6 and FIG. 7. FIG. 6 a schematic diagram of the liquid crystal display device 100 and FIG. 7 is a plan view diagram of the layout of a portion of the pixel P11-P24 of the liquid crystal display device 100. As illustrated in FIG. 6, liquid crystal display device 100 includes a liquid crystal display panel 101, driving control circuits 212a and 212b, and a backlight module 111. The liquid crystal display panel 101 includes a first substrate 202, a polarizer 208 disposed at the surface of the first substrate 202, a second substrate 204 disposed opposite to the first substrate 202, a polarizer 210 disposed at the surface of the second substrate 204, and a liquid crystal layer 206 disposed between the first substrate 202 and the second substrate 204. The first substrate 202 may be a color filter substrate and the second substrate 204 may be a thin film transistor array substrate. Driving control circuits 212a and 212b are disposed at the surface of the second substrate 204; previously discussed first gate driver 103, the second gate driver 105, the source driver 107 and the timing controller 109 may also be included to drive and control the pixels P₁₁-Pᵢⱼ. Although FIG. 6 only illustrates two driving control circuits 212a and 212b of two sides, the liquid crystal display device 100 in fact may include 3 or more driving control circuits on each side. In the embodiments illustrated in FIG. 1 and FIG. 6, the first gate driver 103 and the second gate driver 105 may be disposed at the driving control circuits 212a and 212b respectively and opposite to each other on the liquid crystal display panel 101 such that the first gate driver 103 and the second gate driver 105 are disposed at two opposite sides of the liquid crystal layer 206.

Please refer to FIG. 7. Pixels P₁₁-P₂₄ of FIG. 7 also follow the pixel connection rules illustrated in FIG. 3. In addition, using the present design layout, the present invention utilizes the column inversion driving manner to achieve the advantages of the dot inversion polarity distribution. Moreover, the HSD driving method of liquid crystal display panel 101 dimidiates the amount of data lines; together with the design layout of the present invention, the aperture ratio of the pixels P₁₁-Pᵢⱼ is further increased. As for the layout of the present embodiment, the aperture ratio of the pixels P₁₁-Pᵢⱼ achieves 56.01%.

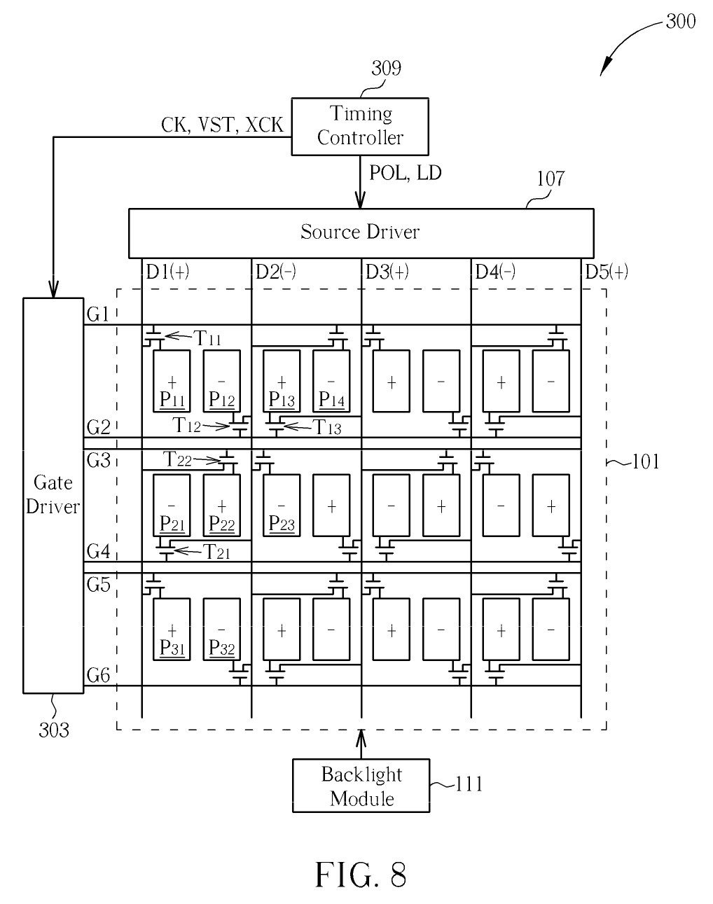

FIG. 8 is a block diagram of a liquid crystal display device 300 of a second embodiment. The primary distinction between the first and the second embodiments of the liquid crystal display devices 100 and 300 is the liquid crystal display device of the second embodiment only includes one gate driver 303. The gate driver 303 is coupled to all the gate lines G₁-Gₓ on the liquid crystal display panel 101, replacing the functions of the first and second gate drivers 103, 105. As illustrated in FIG. 8, the liquid crystal display device 300 includes a liquid crystal display panel 101, a gate driver 303, a source driver 107, a timing controller 309, and a backlight module 111. The gate driver 303 may be disposed at one side of the liquid crystal display panel 101 to supply scan signals for all the gate lines in the liquid crystal display panel 101 in a serial way. Operation of the gate driver 303 is controlled by the control signal CK, VST, XCK from the timing controller 309. Otherwise, the liquid crystal display device 100 and the liquid crystal display device 300 are similar in structure and operating process.

In summary, the pixel array of the liquid crystal display panel utilizes the HSD driving method, and each two pixels that are adjacent in an array location are connected to a different data line. During a frame period of the liquid crystal display device, the liquid crystal display panel utilizes the column inversion driving manner, outputting signals of a same polarity to every data line to achieve the dot inversion polarity distribution. Therefore, the present invention not only greatly reduced the power consumption and loading of the source driver, and increased the aperture ratio, but also decreased the flicker effect of the liquid crystal display panel.

Those skilled in the art will readily observe that numerous modifications and alterations of the device and method may be made while retaining the teachings of the invention.

What is claimed is:

1. A liquid crystal display device, comprising:
a liquid crystal display panel, comprising:
a plurality of gate lines;
a plurality of data lines; and
a plurality of pixels, arranged in matrix form;
wherein, a (4n+1)th gate line is coupled to a pixel of a (4m+1)th column of a (2n+1)th row and a pixel of a (4m+4)th column of a (2n+1)th row;
a (4n+2)th gate line is coupled to a pixel of a (4m+2)th column of a (2n+1)th row and a pixel of a (4m+3)th column of a (2n+1)th row;
a (4n+3)th gate line is coupled to a pixel of a (4m+2)th column of a (2n+2)th row and a pixel of a (4m+3)th column of a (2n+2)th row;
a (4n+4)th gate line is coupled to a pixel of a (4m+1)th column of a (2n+2)th row and a pixel of a (4m+4)th column of a (2n+2)th row;
a (2m+1)th data line is coupled to a pixel of a (4m+1)th column of a (2n+1)th row, and a pixel of a (4m+2)th column of a (2n+2)th row;
a (2m+2)th data line is coupled to a pixel of a (4m+2)th column and a (4m+4)th column of a (2n+1)th row, and a pixel of a (4m+1)th column and a (4m+3)th column of a (2n+2)th row;
a (2m+3)th data line is coupled to a pixel of a (4m+3)th column and a (2n+1)th row, and a pixel of a (4m+4)th column and a (2n+2)th row, wherein m and n are respectively an integer greater than or equal to 0;
at least one driving control circuit for driving and controlling the liquid crystal display panel; and
a backlight module for supplying a light source for the liquid crystal display panel.

2. The liquid crystal display device of claim 1, wherein the driving control circuit comprises:
a gate driver disposed at one side of the liquid crystal display panel and coupled to all of the gate lines of the liquid crystal display device, to generate a scan signal in a serial way.

3. The liquid crystal display device of claim 2, wherein the driving control circuit further comprises:
a source driver, coupled to the data lines of the liquid crystal display, for generating a plurality of display data; and
a timing controller coupled to the gate electrode driver and the source electrode driver for operation control.

4. The liquid crystal display device of claim 1, wherein the driving control circuit comprises:
a first gate driver, disposed at one side of the liquid crystal display and coupled to a (4n+1)th gate line and a (4n+3)th gate line, for supplying a first scan signal in a serial way; and
a second gate driver, disposed at an opposite side of the liquid crystal display and coupled to a (4n+2)th gate line and a (4n+4)th gate line, for supplying a second scan signal in a serial way.

5. The liquid crystal display device of claim 1, wherein each pixel receives a display data from the data lines of the liquid crystal display panel respectively.

6. The liquid crystal display device of claim 5, wherein the display data delivered from a (4m+1)th and a (4m+3)th data lines are a first polarity, the display data delivered from a (4m+2)th and a (4m+4)th data lines are a second polarity during a frame period of the liquid crystal display device, and the first polarity is opposite to the second polarity.

7. The liquid crystal display device of claim 5, wherein the driving control circuit comprises:
a source driver coupled to the data lines of the liquid crystal display panel, for supplying the display data.

8. The liquid crystal display device of claim 7, wherein the driving control circuit comprises:
a timing controller coupled to a first gate driver, a second gate driver and the source driver to control the first gate driver, the second gate driver and the source driver.

9. A liquid crystal display panel, comprising:
a plurality of gate lines;
a plurality of data lines; and
a plurality of pixels, arranged in matrix form;
wherein, a (4n+1)th gate line is coupled to a pixel of a (4m+1)th column of a (2n+1)th row and a pixel of a (4m+4)th column of a (2n+1)th row;
a (4n+2)th gate line is coupled to a pixel of a (4m+2)th column of a (2n+1)th row and a pixel of a (4m+3)th column of a (2n+1)th row;
a (4n+3)th gate line is coupled to a pixel of a (4m+2)th column of a (2n+2)th row and a pixel of a (4m+3)th column of a (2n+2)th row;
a (4n+4)th gate line is coupled to a pixel of a (4m+1)th column of a (2n+2)th row and a pixel of a (4m+4)th column of a (2n+2)th row;
a (2m+1)th data line is coupled to a pixel of a (4m+1)th column of a (2n+1)th row, and a pixel of a (4m+2)th column of a (2n+2)th row;
a (2m+2)th data line is coupled to a pixel of a (4m+2)th column and a (4m+4)th column of a (2n+1)th row, and a pixel of a (4m+1)th column and a (4m+3)th column of a (2n+2)th row; and
a (2m+3)th data line is coupled to a pixel of a (4m+3)th column and a (2n+1)th row, and a pixel of a (4m+4)th column and a (2n+2)th row, wherein m and n are respectively an integer greater than or equal to 0.

10. The liquid crystal display panel of claim 9, wherein a number of gate lines is an even number.

11. The liquid crystal display panel of claim 9, wherein a (4n+1)th and a (4n+3)th gate line receive a first scan signal in a serial way.

12. The liquid crystal display panel of claim 11, wherein a (4n+2)th and a (4n+4)th gate line receive a second scan signal in a serial way.

13. The liquid crystal display panel of claim 9, wherein a (4m+1)th and a (4m+3)th data line send a plurality of first polarity display data, a (4m+2)th and a (4m+4)th data line send a plurality of second polarity display data, and the first polarity is opposite to the second polarity.
